(19) United States
(12) Patent Application Publication
(10) Pub. No.: US 2025/0284941 A1
(43) Pub. Date: Sep. 11, 2025

(54) METHOD FOR CONVERTING TRAINED LANGUAGE MODEL INTO LANGUAGE MODEL HAVING ARCHITECTURE OF MIXTURE OF EXPERTS AND COMPUTING DEVICE USING SAME

(71) Applicant: SAMSUNG SDS CO., LTD., Seoul (KR)

(72) Inventors: Sungyoon KIM, Seoul (KR); Youngjun KIM, Seoul (KR); Sukhoon JUNG, Seoul (KR); Kihyo MOON, Seoul (KR)

(73) Assignee: SAMSUNG SDS CO., LTD., Seoul (KR)

(21) Appl. No.: 19/070,727

(22) Filed: Mar. 5, 2025

(30) Foreign Application Priority Data
Mar. 6, 2024 (KR) 10-2024-0031759
May 29, 2024 (KR) 10-2024-0069865

(51) Int. Cl. G06N 3/0499; G06F 40/40

(52) U.S. Cl. CPC G06N 3/0499; G06F 40/40

(57) ABSTRACT

A processor-implemented method for converting a trained language model into a language model in an architecture of mixture of experts (MoE), and a computing device using the same is provided. The method for converting a trained language model into a language model in an architecture of mixture of experts using a computing device according to an embodiment of the disclosure may include dividing a plurality of layers included in a target language model and extracting a feed-forward network (FFN) included in each of the plurality of layers, generating an MoE block of the MoE language model, which corresponds to the feed-forward network, generating an input tensor, comparing output tensors between the feed-forward network and the MoE block for the input tensor to obtain a first loss, and updating a weight of the MoE block, based on the first loss.

### CROSS-REFERENCE TO RELATED APPLICATIONS

This application claims the benefit under 35 U.S.C. 119 of Korean Patent Application No. 10-2024-0031759, filed on Mar. 6, 2024, in the Korean Intellectual Property Office, and Korean Patent Application No. 10-2024-0069865, filed on May 29, 2024, in the Korean Intellectual Property Office, the entire disclosures of which are hereby incorporated by reference for all purposes.

### BACKGROUND

### 1. Field

The following description relates to a method for converting existing trained language models into MoE language models based on an MoE architecture, and a computing device using the same.

### 2. Description of Related Art

Recently, in large-scale language generation models, the state-of-the-art (SOTA) models trained by applying the architecture of mixture of experts (MoE) have been introduced to complement the limitations of the traditional transformer architecture, which show high performance. The MoE architecture replaces the feed-forward network (FFN) configured as a single dense network for each layer in the existing transformer architecture with a MoE block including multiple dense networks, and enables fast inference by activating only some dense networks during inference.

That is, the MoE architecture has the effect of reducing the number of parameters activated during inference by making the neural network sparse. However, in order to utilize the MoE architecture, the model must be trained using text data from the beginning, making it difficult to easily apply it to non-MoE models to have the same effect as a MoE model.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a processor-implemented method for converting a trained language model into a language model in an architecture of mixture of experts (MoE) with a computing device includes dividing a plurality of layers included in a target language model and extracting a feed-forward network (FFN) included in each of the plurality of layers; generating an MoE block of the MoE language model, which corresponds to the feed-forward network; and generating an input tensor, comparing output tensors between the feed-forward network and the MoE block for the input tensor to obtain a first loss, and updating a weight of the MoE block, based on the first loss.

The MoE block may include a plurality of expert networks in a small FFN structure generated according to configured hyperparameters; and a router configured to determine an importance of the expert networks for the input tensor, and select an expert network to be activated from among the plurality of expert networks.

The updating may include updating the weight of the MoE block based on a determination that the first loss is greater than or equal to a reference value; and extracting the MoE block as a target MoE block based on a determination that the first loss is less than the reference value.

The updating may include regenerating the input tensor based on a determination that the first loss is greater than or equal to the reference value; and comparing output tensors according to the regenerated input tensor to obtain a second loss.

The method may include accumulating the extracted target MoE blocks to generate the MoE language model corresponding to the target language model.

The generating of the MoE language model may include replacing the feed-forward network included in the layer of the target language model with the target MoE block to generate the MoE language model.

The updating may include using a random tensor randomly generated as the input tensor.

The updating may include generating the input tensor by reflecting distribution information of an actual input tensor, which is input when the target language model operates, to the random tensor.

The method may include generating an actual input tensor for the feed-forward network by inputting sample data into the target language model; and performing singular value decomposition (SVD) on a matrix obtained by accumulating the actual input tensors to generate a distribution matrix comprising the distribution information.

The updating may include generating the input tensor by multiplying the random tensor by the distribution matrix.

In a general aspect, a computing device configured to convert a trained language model into a language model in an architecture of mixture of experts (MoE), the computing device comprising one or more processors, wherein the one or more processors are configured to divide a plurality of layers included in a target language model and extract a feed-forward network (FFN) included in each of the plurality of layers; generate an MoE block of the MoE language model, which corresponds to the feed-forward network; and generate an input tensor, compare output tensors between the feed-forward network and the MoE block for the input tensor to obtain a first loss, and update a weight of the MoE block, based on the first loss.

The MoE block may include a plurality of expert networks in a small FFN structure generated according to configured hyperparameters; and a router configured to determine an importance of the expert networks for the input tensor and select an expert network to be activated from among the plurality of expert networks.

The one or more processors may be configured to update the weight of the MoE block based on a determination that the first loss is greater than or equal to a reference value; and extract the MoE block as a target MoE block based on a determination that the first loss is less than the reference value.

The one or more processors may be configured to regenerate the input tensor based on a determination that the first loss is greater than or equal to the reference value; and compare output tensors according to the regenerated input tensor to obtain a second loss.

The one or more processors may be further configured to accumulate the extracted target MoE blocks; and generate the MoE language model corresponding to the target language model.

The one or more processors may be configured to replace the feed-forward network included in the layer of the target language model with the target MoE block to generate the MoE language model.

The one or more processors may be configured to perform the updating using a random tensor randomly generated as the input tensor.

The one or more processors may be configured to perform the updating by reflecting distribution information of an actual input tensor, which is input when the target language model operates, to the random tensor to generate the input tensor.

The one or more processors may be configured to generate an actual input tensor for the feed-forward network by inputting sample data into the target language model; and perform singular value decomposition (SVD) on a matrix obtained by accumulating the actual input tensors to generate a distribution matrix comprising the distribution information.

Other features and aspects will be apparent from the following detailed description, the drawings, and the claims.

### BRIEF DESCRIPTION OF DRAWINGS

FIG. 1 is a schematic diagram illustrating an example conversion device that converts a non-MoE language model into a MoE language model, in accordance with one or more embodiments.

FIG. 2 is a schematic diagram illustrating the structure of an example feed-forward network, in accordance with one or more embodiments.

FIG. 3 is a schematic diagram illustrating the structure of a MoE block, in accordance with one or more embodiments.

FIG. 4 is a block diagram illustrating an example conversion device, in accordance with one or more embodiments.

FIG. 5 is a block diagram illustrating an example conversion device, in accordance with one or more embodiments.

FIG. 6 is a block diagram illustrating an example computing device, in accordance with one or more embodiments.

FIG. 7 and FIG. 8 are flowcharts illustrating an example conversion method for converting a trained language model into a language model in an architecture of mixture of experts, in accordance with one or more embodiments.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

One or more examples may provide a method for converting a trained language model into a language model in an architecture of mixture of experts, which is able to convert non-MoE language models into MoE language models that perform substantially the same operation without learning based on separate text data, and a computing device using the same.

One or more examples may provide a method for converting a trained language model into a language model in an architecture of mixture of experts, which converts a non-MoE language model into a corresponding MoE language model by learning a MoE block so as to generate substantially the same output tensor as the feed-forward networks of layers constituting the non-MoE language model, and a computing device using the same.

One or more examples may provide a method for converting a trained language model into a language model in an architecture of mixture of experts, which generates distribution information from input tensors of feed-forward networks in a non-MoE language model accumulated from sample data, and generates input tensors similar to actual vectors, based on the distribution information, to utilize them for learning the MoE block, and a computing device using the same.

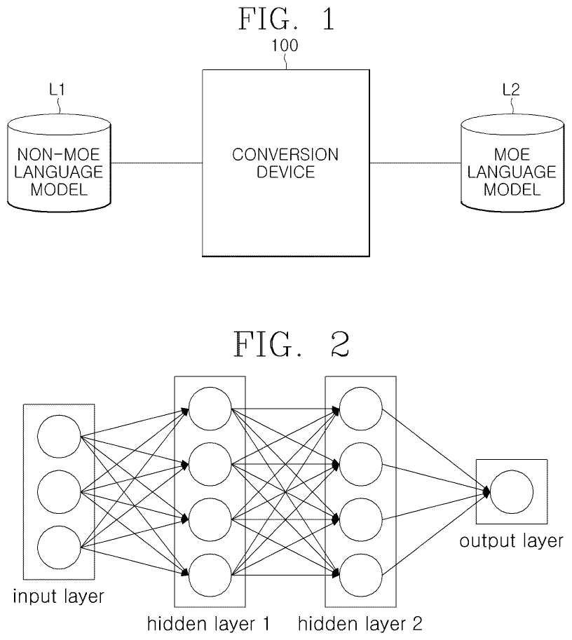

FIG. 1 is a schematic diagram illustrating an example conversion device that converts a non-MoE language model into a MoE language model, in accordance with one or more embodiments. Referring to FIG. 1, the conversion device 100 may convert a trained non-MoE language model L1 into a MoE language model L2.

The non-MoE language model L1 may be a trained language model with a typical transformer structure. The non-MoE language model L1 may include a feed-forward network (FFN) including multiple layers and a single dense network included in the corresponding layer.

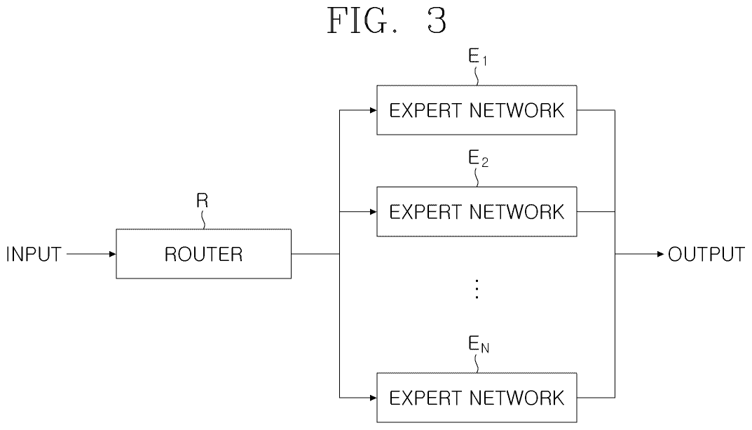

As illustrated in FIG. 2, the FFN may be configured such that multiple nodes form a single dense network. In an example, the number of nodes included in the hidden layer (hidden layer 1 and hidden layer 2) may increase more than the number of nodes included in the input layer, and then the output layer may be configured to have a preset number of output nodes. The FFN may set weights for each node through learning, and may then perform forward weight operations on all nodes in the dense network for the input tensor to finally generate an output tensor. That is, the FFN may generate the final output tensor by performing operations between all nodes and input tensors.

The MoE language model L2 may be a language model with an MoE architecture proposed to complement the limitations of the existing traditional transformer structure. Most language models that have recently demonstrated state-of-the-art (SOTA) performance are implemented with the MoE architecture. The MoE language model L2 replaces the FFN with an MoE block including multiple dense networks, and the MoE block may activate only some of multiple dense networks to generate an output tensor when inferring the input tensor. That is, since the MoE block may drastically reduce a computation amount, compared to the FFN during inference, the MoE language model L2 may provide a relatively fast inference result.

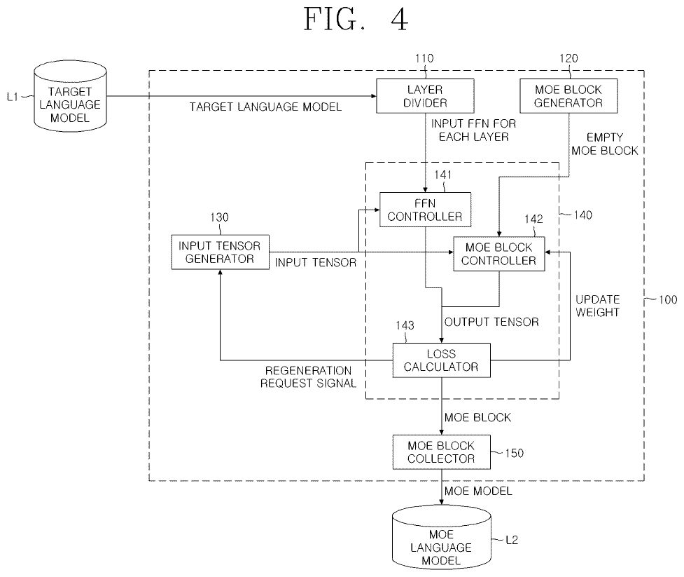

Referring to FIG. 3, the MoE block may include multiple expert networks E1, E2, . . . , and EN, and a router R. In an example, the number of expert networks E1, E2, . . . , and EN included in the MoE block may be determined according to the configured hyperparameters, and each expert network E1, E2, . . . , or EN may have a small FFN structure. The router R may obtain the importance of each expert network E1, E2, . . . , or EN for the input tensor and select an expert network E1, E2, . . . , or EN to be activated from among the multiple expert networks E1, E2, . . . , and EN, based on the importance. In an example, the number of expert networks E1, E2, . . . , and EN selected by the router R may also be pre-determined. For example, the router R may select two expert networks E1, E2, . . . , and EN in order of importance and perform the operation. That is, when utilizing the MoE block, since two expert networks to be activated perform the operation on the input tensor, it is possible to drastically reduce the amount of operation, compared to the existing FFN. Additionally, since the MoE block selects and applies the one with the highest importance from among the multiple expert networks, it may provide results equivalent to the existing FFN in performance such as accuracy.

In an example, the MoE block may include one router and eight expert networks, and when generating a new word, the router R may obtain the importance of each expert network indicating how important it is in generating the word. Thereafter, the router R may select two expert networks with the highest importance and cause the selected expert networks to perform inference to generate a word corresponding to the input. This enables each expert network to obtain better results in a specific situation during the learning process of the MoE block, so that some expert networks may be selected for inference without performing operations on all expert networks during inference. Therefore, the MoE language model may provide an improved inference speed, compared to a non-MoE language model with a similar total number of parameters.

The conversion device 100 may configure the non-MoE language model as a target language model and convert the target language model into the MoE language model in the MoE architecture. That is, an existing trained non-MoE language model is able to be converted into a MoE language model, it is possible to improve the inference speed while maintaining the performance of the non-MoE language model. Additionally, although various improvement techniques for the MoE language model are developed, it is difficult to apply the same to the non-MoE language model, but if a non-MoE language model is converted into a MoE language model using the conversion device 100, the improvement techniques may be applied, so it is possible to improve the practicality of existing trained non-MoE language models.

However, it may be beneficial that the MoE language model implement a model including multiple MoE blocks and then directly learn using learning data such as text data. That is, since the MoE language model may perform learning while fixing the MoE architecture, it may be difficult to convert existing trained language models into a MoE architecture using a non-MoE architecture.

Additionally, there have been studies on converting non-MoE language models such as bidirectional encoder representations from transformer (BERT) and T5 into MoE language models. But recently, new structures such as gate networks, in addition to BERT and T5, have been applied to the non-MoE language models. Accordingly, it may be difficult to apply them to these latest non-MoE language models. Additionally, in the past, in the process of separating the dense networks in the non-MoE language model into respective expert networks, learning data such as text data for inference was required, so it may take a long time and resources to learn this. Additionally, existing studies are based on the activation functions of the non-MoE language model, but since the activation functions used in BERT and T5 are not used these days, it is difficult to apply this method.

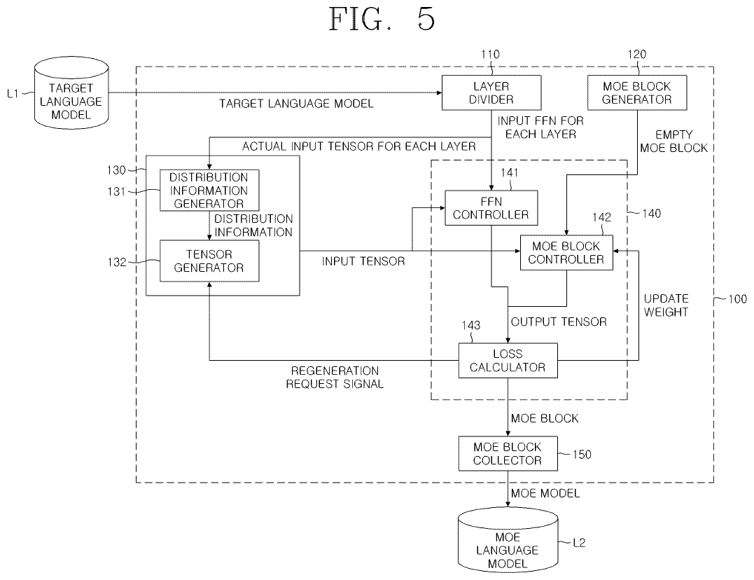

On the other hand, the conversion device 100, in accordance with one or more embodiments, may perform conversion by loading the FFN of each of layers constituting the non-MoE language model L1 and then training the MoE block to generate the same output tensor as the FFN for the same input tensor. At this time, since a tensor including multiple vectors, instead of text data, is input to the FFN, it is possible to utilize a random tensor that is randomly generated when learning the MoE block. Therefore, the conversion device 100 may easily learn by utilizing a random tensor that is randomly generated without building a data set including each piece of text data for learning. Additionally, since the random tensor is able to be conveniently generated according to the settings, it is possible to freely generate it without limitations as to the size of the learning data, etc. Hereinafter, the conversion device 100, in accordance with one or more embodiments, will be described with reference to FIG. 4.

FIG. 4 is a block diagram illustrating an example conversion device, in accordance with one or more embodiments.

Referring to FIG. 4, the conversion device 100, in accordance with one or more embodiments, may include a layer divider 110, a MoE block generator 120, an input tensor generator 130, a learning device 140, and a MoE block collector 150.

The layer divider 110 may divide a plurality of layers included in a target language model L1 and extract an FFN included in the corresponding layer. That is, the layer divider 110 may configure any one of the non-MoE language models as a target language model L1 and sequentially extract FFNs included in the respective layers in order to generate an MoE block corresponding to the FFN in the target language model L1. Since the target language model L1 has already completed learning, weights may be configured for the respective FFNs through learning.

In an example, if the target language model L1 is implemented as LLaMa 2, the target language model L1 may be loaded using a framework such as HuggingFace, and FFNs included in the respective layers may be extracted using the framework. Since LLaMA 2 is configured as 32 layers, the layer divider 110 may extract 32 FFNs corresponding to the respective layers. In this example, the respective FFNs may include a first dense network in which the size of the input tensor is converted from 4096 to 11008, and a second dense network in which the size of the input tensor is converted from 11008 to 4096.

The MoE block generator 120 may generate a MoE block corresponding to the extracted FFN. In an example, the MoE block is included in the MoE language model L2, and may include an expert network of N small-scale FFN structures, and a router that evaluates the importance of the expert network and selects an expert network to be activated. However, the router and expert network in the MoE block generated by the MoE block generator 120 may not have their respective weights configured. That is, the MoE block generator 120 may generate a MoE block (empty MoE block) with no configured weight, and then the learning device 140 may learn the MoE block and configure each weight.

Here, the expert network generated by the MoE block generator 120 may have an FFN structure that is 1/N of the corresponding FFN (where, N is the number of expert networks included in the MoE block), and the router may be a single dense network that calculates the importance for N expert networks.

In an example, if there are 8 expert networks, the router may generate 8 outputs corresponding to the respective expert networks for 4096 inputs to the FFNs of LLaMA 2. In an example, the outputs of the router may be real numbers between 0 and 1, and the sum of the 8 outputs may be 1. Additionally, since the target language model L1 increases the input tensor of 4096 in the first dense network to 11008, each expert network may be manufactured to include 11008/8 nodes. That is, the 11008 nodes included in the FFN may be manufactured to be divided and included in each of the 8 expert networks. Therefore, the FFN and the MoE block may include the same number of parameters, but the MoE block may provide a faster response.

The input tensor generator 130 may generate an input tensor input to each of the FFN and MoE block, and in this example, the input tensor may be a random tensor that is randomly generated. That is, the FFN may have a previously trained weight, so no matter whether any input tensor is entered into the FFN, a corresponding output tensor may be generated according to the previously trained weight. Here, if the MoE block generates an output tensor that is substantially the same as the FFN for the same input tensor, it is possible to replace the FFN with the MoE block. Therefore, the input tensor generator 130 may generate input tensors to learn the weights of the MoE block. That is, the MoE block may be trained using the random tensor randomly generated by the input tensor generator 130, and since the random tensor may be conveniently generated according to the settings, it may be freely generated without restrictions on the size of the learning data, etc.

The learning device 140 may compare the output tensors between the FFN and the MoE block for the input tensor to obtain a loss, and update the weight of the MoE block, based on the loss. That is, the FFN controller 141 may input the input tensor to the extracted FFN to generate a corresponding output tensor, and the MoE block controller 142 may input the input tensor to the generated MoE block to generate a corresponding output tensor. Thereafter, the loss calculator 143 may compare the respective output tensors with each other to calculate a loss. In an example, the difference in the output tensor between the FFN and the MoE block may be defined as the loss. The learning device 140 may repeatedly perform learning on the neural network in the MoE block until the corresponding loss is reduced to a reference value or less. The reference value may be directly configured by the user as a hyperparameter, and if the loss is reduced to the reference value or less during learning, early stopping may be applied to immediately end learning.

Specifically, the loss calculator 143 may update the weight of the MoE block if each loss is greater than or equal to the reference value, and may extract the MoE block as a target MoE block if the loss is less than the reference value. That is, if the loss is less than the reference value, the MoE block may be regarded as generating an output tensor that is substantially the same as the FFN, so the learning may be stopped and the trained MoE block may be extracted as a target MoE block. The target MoE block extracted here may be used to generate a MoE language model.

On the other hand, if the loss is equal to or greater than the reference value, the loss calculator 143 may transmit a regeneration request signal to the input tensor generator 130 to regenerate the input tensor. The FFN controller 141 and the MoE block controller 142 may generate the output tensors of the FFN and MoE block according to the regenerated input tensor, and the loss calculator 142 may compare the respective output tensors again to obtain a loss. That is, in order to prevent problems such as overfitting, the learning device 140 may generate a new input tensor for each repetition, obtain the loss, and update the weights according thereto

In an example, the learning device 140 may sequentially extract FFNs of layers included in the target language model L1 and learn the corresponding MoE blocks one by one. However, depending on the embodiment, the learning device 140 may extract the respective FFNs from multiple layers and then learn multiple MoE blocks in parallel. In this example, the input tensor generator 130 may provide the same input tensor to multiple FFNs, and the learning device 140 may perform learning on the MoE blocks corresponding to the respective FFNs, based on the same input tensor.

The MoE block collector 150 may accumulate the extracted target MoE blocks and generate a MoE language model L2 corresponding to the target language model L1. That is, the MoE block collector 150 may generate the MoE language model L2 by replacing each feed-forward network included in the layer in the target language model L1 with the corresponding target MoE block.

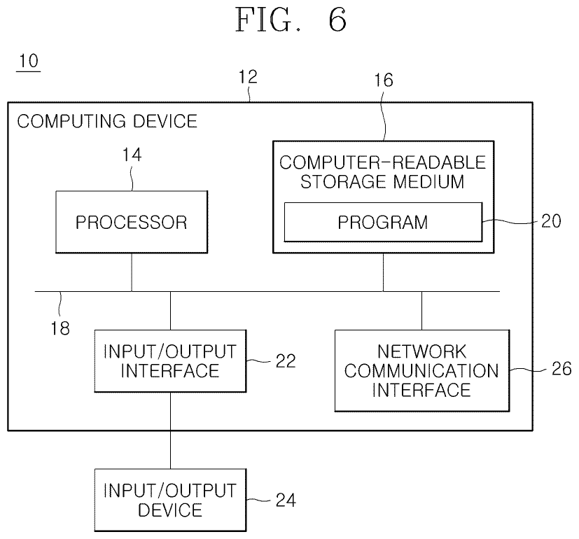

Meanwhile, depending on the embodiment, it is also possible to generate the input tensor by reflecting distribution information of the actual input tensor input during the operation of the target language model. That is, the input tensor may be transformed to be similar to the input tensor of the FFN generated according to the actual input text data, instead of being randomly generated, thereby improving the learning performance for the MoE block. In this case, as illustrated in FIG. 5, the input tensor generator 130 may include a distribution information generator 131 and a tensor generator 132.

The distribution information generator 131 may generate distribution information of an actual input tensor input during the operation of the target language model L1. Specifically, the distribution information generator 131 may input sample data into the target language model L1 and accumulate the actual input tensor of the FFN for each layer generated by the sample data, thereby generating a target matrix corresponding to the FFN. That is, a small amount of sample data, such as text data, may be input to the target language model L1, and the input tensor input to the FFN of the corresponding layer may be accumulated to generate a target matrix.

Afterwards, the distribution information generator 131 may perform singular value decomposition (SVD) on the target matrix to extract a distribution matrix including distribution information from the target matrix. Specifically, the target matrix A may be expressed as a product of three matrices, A=U*S*V, by singular value decomposition, where S is a diagonal matrix including singular values, and V corresponds to a distribution matrix including distribution information. Therefore, the distribution information generator 131 may extract a distribution matrix V through singular value decomposition on the target matrix A.

For example, if 1,000 pieces of sample data are input to the LLaMA 2 7B model, about 100,000 input tensors may be generated for a specific layer, and if these are accumulated in the row direction, a target matrix A (100,000*4096) corresponding to the layer may be obtained (the number of input nodes for the FFN of the LLaMA 2 7B model is 4096). The distribution information generator 131 may apply singular value decomposition to the target matrix A, and the target matrix A is expressed as the product of three matrices of U (100,000*4096), S (4096*4096), and V (4096*4096). In this example, S corresponds to a diagonal matrix in which singular values are listed in order of size, and the distribution information generator 131 may extract the distribution matrix V for the target matrix A.

Depending on the embodiment, truncated forms of U′, S′, and V′ may be obtained by deleting rows and columns of small singular values from S and deleting corresponding columns of U and rows of V, respectively, and in this example, their product may be similar to the target matrix A. That is, the distribution information generator 131 may extract the truncated form of V′ as a distribution matrix, and may also generate an input tensor based on this. For example, if S, which includes 4096 singular values, is truncated to have only 1024 singular values, U′, S′, and V′ may have the forms of 100,000*1024, 1024*1024, and 1024*4096, respectively, and the distribution information generator 131 may extract the truncated form of V′ as a distribution matrix.

The tensor generator 132 may generate an input tensor by multiplying a random tensor by a distribution matrix. When generating an input tensor by multiplying a random tensor by a distribution matrix, it is mathematically known that the input tensor conforms to the distribution of each row of the target matrix. Therefore, in an example of generating a target matrix A by inputting 1000 pieces of sample data to the LLaMA 2 7B model, the tensor generator 132 may obtain a distribution matrix V (4096*4096) through singular value decomposition and generate an input tensor by multiplying the distribution matrix V by a random tensor (row vector) with a length of 4096. In this example, the input tensor may be generated to follow the distribution of each row of the target matrix A. That is, the tensor generator 132 may generate random input tensors to have a distribution similar to the respective input tensors generated by the sample data.

Additionally, depending on the embodiment, it is also possible to obtain the truncated forms of U′, S′, and V′, respectively, and then generate the input tensor, based on the truncated form of V′. For example, if S, which initially includes 4096 singular values, is truncated to have only 1024 singular values, U′, S′, and V′ may have the forms of 100,000*1024, 1024*1024, and 1024*4096, respectively. In this example, the tensor generator 132 may multiply the random tensor having a length of 1024 by V′ to obtain the input tensor having a length of 4096, and in this example, it may follow the distribution of each row of the target matrix A of the input tensor.

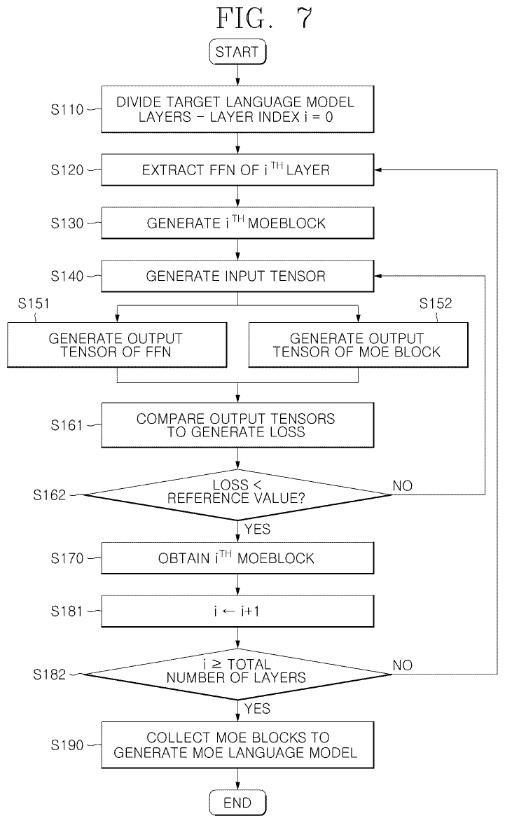

FIG. 6 is a block diagram illustrating a computing environment 10 configured to be implemented in the embodiments. In the illustrated embodiment, each element may have different operations and capabilities other than those described below, and may include additional elements other than those described below.

The illustrated computing environment 10 includes a computing device 12. In an embodiment, the computing device 12 may be a conversion device 100, in accordance with one or more embodiments.

The computing device 12 includes one or more processors 14, a computer-readable storage medium 16, and a communication bus 18. The processor 14 may cause the computing device 12 to operate according to the embodiment described above. For example, the processor 14 may execute one or more programs or codes stored in the computer-readable storage medium 16. The one or more programs may include one or more computer-executable instructions, which, when executed by the processor 14, may cause the computing device 12 to perform operations according to the embodiments.

The computer-readable storage medium 16 is configured to store computer-executable instructions or program code, program data, and/or other suitable forms of information. The program 20 stored in the computer-readable storage medium 16 includes a set of instructions executable by the processor 14. In an embodiment, the computer-readable storage medium 16 may be memory (volatile memory such as random access memory, nonvolatile memory, or a suitable combination thereof), one or more magnetic disk storage devices, optical disk storage devices, flash memory devices, or any other form of storage medium capable of being accessed by the computing device 12 and storing desired information, or a suitable combination thereof.

The communication bus 18 interconnects the processor 14, the computer-readable storage medium 16, and other various elements of the computing device 12.

The computing device 12 may also include one or more input/output interfaces 22 that provide interfaces for one or more input/output devices 24, and one or more network communication interfaces 26. The input/output interface 22 and the network communication interface 26 are connected to the communication bus 18. The input/output device 24 may be connected to other components of the computing device 12 through the input/output interface 22. The example input/output device 24 may include input devices such as a pointing device (such as a mouse or a trackpad), a keyboard, a touch input device (such as a touchpad or a touchscreen), a voice or sound input device, various types of sensor devices and/or photographing devices, and/or output devices such as a display device, a printer, a speaker, and/or a network card. The example input/output device 24 may be included inside the computing device 12 as a component that constitutes the computing device 12, or may be configured as a separate device distinct from the computing device 12 and then connected to the computing device 12.

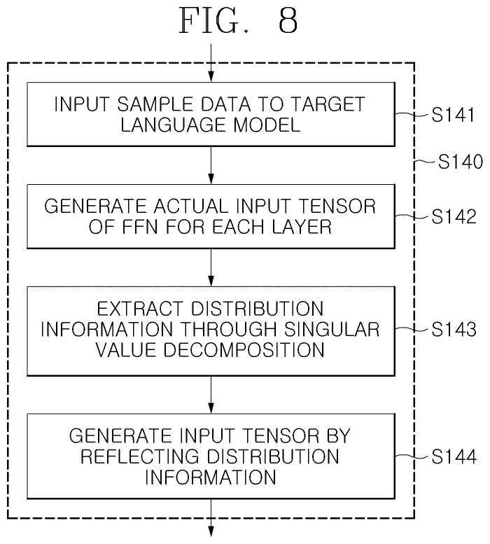

FIGS. 7 and 8 are flowcharts showing a conversion method for converting a trained language model into a language model in an architecture of mixture of experts according to an embodiment of the disclosure. In an example, the respective steps of FIGS. 7 and 8 may be performed by the conversion device, in accordance with one or more embodiments.

Referring to FIG. 7, the conversion device may divide a plurality of layers included in a target language model (operation S110), and extract feed-forward networks (FFNs) included in the layers (operation S120). That is, indexes i for the plurality of layers included in the target language model may be configured (i=0), and a corresponding FFN may be extracted from the i^{th} layer.

In addition, the conversion device may generate the i^{th} MoE block of the MoE language model corresponding to the corresponding FFN (operation S130). In an example, the MoE block may include a plurality of expert networks in a small FFN structure generated according to the configured hyperparameters, and a router that determines the importance of the expert networks for the input tensor and selects an expert network to be activated from among the plurality of expert networks. In an example, the router and expert network included in the i^{th} MoE block may not have their respective weights configured. That is, a MoE block (empty MoE block) with no weight configured may be generated, and then the MoE block may be learned to configure respective weights.

After that, the conversion device may generate an input tensor (operation S140), generate an output tensor of the FFN for the input tensor (operation S151) and an output tensor of the MoE block therefor (operation S152), then compare the respective output tensors to obtain a loss (operation S161), and update the weight of the MoE block, based on the loss. That is, the converter may perform learning on the weight in the MoE block so that the MoE block generates the same output tensor as the FFN. Here, the conversion device may utilize a random tensor that is randomly generated as an input tensor.

Specifically, if the loss is greater than or equal to a reference value (operation S162), the conversion device may update the weight of the MoE block, regenerate an input tensor (operation S140), compare the output tensors according to the regenerated input tensor (operations S151 and S152), and obtain a loss for the updated weight (operation S161). That is, the above-described steps may be repeated until the loss is less than the reference value.

On the other hand, if the loss is less than the reference value (operation S162), the MoE block may be extracted as a target MoE block to obtain the i^{th} MoE block (operation S170). When the i^{th} MoE block is obtained, the index of the layer may be increased (operation S181), and the step may be repeated until the index reaches the total number of layers of the target language model, thereby extracting MoE blocks for respective layers (operation S182).

Afterwards, the extracted target MoE blocks may be accumulated to generate a MoE language model corresponding to the target language model (operation S190). That is, the FFN included in the layer of the target language model may be replaced with the target MoE block to generate the MoE language model.

Meanwhile, depending on the embodiment, the input tensor may be generated by reflecting the distribution information of an actual input tensor, which is input during the operation of the target language model, to the random tensor. That is, the input tensor may be transformed to be similar to the input tensor of the FFN generated according to the actually input text data, instead of being randomly generated, thereby improving the learning performance for the MoE block.

Specifically, referring to FIG. 8, the conversion device may input sample data to the target language model (operation S141), thereby generating the actual input tensor for the FFN (operation S142). That is, the actual input tensors of the FFNs for respective layers generated by the corresponding sample data may be accumulated to generate the target matrix corresponding to each FFN. Afterwards, the conversion device may extract a distribution matrix including distribution information by performing singular value decomposition on the matrix in which the actual input tensors are accumulated (operation S143). Specifically, the target matrix A may be expressed as a product of three matrices, A=U*S*V, by singular value decomposition, where S is a diagonal matrix including singular values, and V corresponds to a distribution matrix including distribution information. Therefore, the conversion device may extract a distribution matrix V through singular value decomposition on the target matrix A.

Afterwards, the conversion device may generate an input tensor by reflecting the distribution information (operation S144). That is, the input tensor may be generated by multiplying a random tensor by a distribution matrix. When generating an input tensor by multiplying a random tensor by a distribution matrix, it is mathematically known that the input tensor conforms to the distribution of each row of the target matrix. Therefore, the conversion device may generate random input tensors to have a distribution similar to the respective actual input tensors generated by the sample data.

The disclosure described above may be implemented as a computer-readable code on a medium in which a program is recorded. The computer-readable medium may be a medium that continuously stores a computer-executable program or temporarily stores it for execution or download. In addition, the medium may be a variety of recording means or storage means in the form of a single piece of hardware or a combination of multiple pieces of hardware, and may not be limited to a medium directly connected to a computer system, but may also be distributed on a network. Examples of the medium may include magnetic media such as hard disks, floppy disks, and magnetic tapes, optical recording media such as CD-ROMs and DVDs, magneto-optical media such as floptical disks, ROMs, RAMs, flash memories, and the like, which are configured to store program instructions. In addition, examples of other media may include recording media or storage media managed by app stores that distribute applications, or sites or servers that supply or distribute various software. Therefore, the above detailed description should not be construed as limiting the disclosure in all respects and should be considered as examples.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method for converting a trained language model into a language model in an architecture of mixture of experts (MoE) with a computing device, the method comprising:
dividing a plurality of layers included in a target language model and extracting a feed-forward network (FFN) included in each of the plurality of layers;
generating an MoE block of the MoE language model, which corresponds to the feed-forward network; and
generating an input tensor, comparing output tensors between the feed-forward network and the MoE block for the input tensor to obtain a first loss, and updating a weight of the MoE block, based on the first loss.

2. The method of claim 1,
wherein the MoE block comprises:
a plurality of expert networks in a small FFN structure generated according to configured hyperparameters; and
a router configured to determine an importance of the expert networks for the input tensor, and select an expert network to be activated from among the plurality of expert networks.

3. The method of claim 1,
wherein the updating comprises:
updating the weight of the MoE block based on a determination that the first loss is greater than or equal to a reference value; and
extracting the MoE block as a target MoE block based on a determination that the first loss is less than the reference value.

4. The method of claim 3,
wherein the updating comprises:
regenerating the input tensor based on a determination that the first loss is greater than or equal to the reference value; and
comparing output tensors according to the regenerated input tensor to obtain a second loss.

5. The method of claim 3, further comprising accumulating the extracted target MoE blocks to generate the MoE language model corresponding to the target language model.

6. The method of claim 5,
wherein the generating of the MoE language model comprises replacing the feed-forward network included in the layer of the target language model with the target MoE block to generate the MoE language model.

7. The method of claim 1, wherein the updating comprises using a random tensor randomly generated as the input tensor.

8. The method of claim 1, wherein the updating comprises generating the input tensor by reflecting distribution information of an actual input tensor, which is input when the target language model operates, to the random tensor.

9. The method of claim 8, further comprising:
generating an actual input tensor for the feed-forward network by inputting sample data into the target language model; and
performing singular value decomposition (SVD) on a matrix obtained by accumulating the actual input tensors to generate a distribution matrix comprising the distribution information.

10. The method of claim 9, wherein the updating comprises generating the input tensor by multiplying the random tensor by the distribution matrix.

11. A non-transitory computer-readable program stored in a medium, in combination with hardware and configured to execute the method of claim 1.

12. A computing device configured to convert a trained language model into a language model in an architecture of mixture of experts (MoE), the computing device comprising one or more processors,
wherein the one or more processors are configured to:
divide a plurality of layers included in a target language model and extract a feed-forward network (FFN) included in each of the plurality of layers;
generate an MoE block of the MoE language model, which corresponds to the feed-forward network; and
generate an input tensor, compare output tensors between the feed-forward network and the MoE block for the input tensor to obtain a first loss, and update a weight of the MoE block, based on the first loss.

13. The computing device of claim 12,
wherein the MoE block comprises:
a plurality of expert networks in a small FFN structure generated according to configured hyperparameters; and
a router configured to determine an importance of the expert networks for the input tensor and select an expert network to be activated from among the plurality of expert networks.

14. The computing device of claim 12,
wherein the one or more processors are configured to:
update the weight of the MoE block based on a determination that the first loss is greater than or equal to a reference value; and
extract the MoE block as a target MoE block based on a determination that the first loss is less than the reference value.

15. The computing device of claim 14,
wherein the one or more processors are configured to:
regenerate the input tensor based on a determination that the first loss is greater than or equal to the reference value; and
compare output tensors according to the regenerated input tensor to obtain a second loss.

16. The computing device of claim 14,
wherein the one or more processors are further configured to:
accumulate the extracted target MoE blocks; and
generate the MoE language model corresponding to the target language model.

17. The computing device of claim 16,
wherein the one or more processors are configured to replace the feed-forward network included in the layer of the target language model with the target MoE block to generate the MoE language model.

18. The computing device of claim 12,
wherein the one or more processors are configured to perform the updating using a random tensor randomly generated as the input tensor.

19. The computing device of claim 12,
wherein the one or more processors are configured to perform the updating by reflecting distribution information of an actual input tensor, which is input when the target language model operates, to the random tensor to generate the input tensor.

20. The computing device of claim 19,
wherein the one or more processors are configured to:
generate an actual input tensor for the feed-forward network by inputting sample data into the target language model; and
perform singular value decomposition (SVD) on a matrix obtained by accumulating the actual input tensors to generate a distribution matrix comprising the distribution information.
